(19) United States
(12) Patent Application Publication
(10) Pub. No.: US 2022/0203952 A1
(43) Pub. Date: Jun. 30, 2022

(54) ELECTROMECHANICAL DISK BRAKE HAVING A PARKING BRAKE ACTUATOR FOR MOTOR VEHICLES

(71) Applicant: ZF CV Systems Global GmbH, Bern (CH)

(72) Inventors: Peter Beier, Wunstorf (DE); Jan Reiners, Hannover (DE)

(21) Appl. No.: 17/695,542

(22) Filed: Mar. 15, 2022

Related U.S. Application Data
(63) Continuation of application No. PCT/EP2020/077905, filed on Oct. 6, 2020.

(30) Foreign Application Priority Data
Oct. 16, 2019 (DE) 10 2019 127 901.1

(51) Int. Cl. B60T 13/74; F16D 55/226; B60T 1/06; F16D 65/18; H02K 7/06; H02K 7/12

(52) U.S. Cl. CPC B60T 13/746; F16D 55/226; B60T 1/065; F16D 2127/06; H02K 7/06; H02K 7/125; F16D 65/18

(57) ABSTRACT

The disclosure relates to an electromechanical disk brake having a parking brake actuator for motor vehicles. Parking brake actuators are used to prevent a vehicle from rolling away from the stationary state. In conventional disk brakes, a brake cylinder which is assigned to the disk brake is generally equipped with a mechanically actuated parking brake function. At the same time, the principle of the parking brake function used in a conventional disk brake cannot be used. It is an object of the disclosure to provide an electromechanical disk brake having a parking brake actuator, which is cost-effective and needs little construction space. The object can, for example, be achieved via an electromechanical disk brake having a parking brake actuator embodied as an electromagnetic linear drive.

### CROSS REFERENCE TO RELATED APPLICATIONS

This application is a continuation application of international patent application PCT/EP2020/077905, filed Oct. 6, 2020 designating the United States and claiming priority from German application 10 2019 127 901.1, filed Oct. 16, 2019, and the entire content of both applications is incorporated herein by reference.

### TECHNICAL FIELD

The disclosure relates to an electromechanical disk brake having a parking brake actuator for motor vehicles. Parking brake actuators are used to prevent a vehicle from rolling away from the stationary state. In the case of conventional disk brakes, a brake cylinder assigned to the disk brake is generally equipped with a mechanically actuated parking brake function. The principle of the parking brake function used in a conventional disk brake cannot be used in an electromechanical disk brake.

### BACKGROUND

Solutions for providing a parking brake function in an electromechanically actuated disk brake are known. US 2008/0217117 thus solves the problem with a complex and costly redundant mechanical parking brake actuator.

EP2650557A1 proposes another solution with a latching lug on a cam disk. This actuation principle is associated with the actuation of the disk brake by means of the cam disk and cannot be used for other actuation mechanisms. The latching lug is arranged in a fixed position and is part of the application mechanism. In order not to interfere with the actual operation of the brake kinematics, the latching lug is provided at the point of maximum application. The arrangement of the latching lug has the effect that the parking brake is inevitably actuated with the maximum possible application force. The regularly high application forces that are present and that are also not required for parking unnecessarily load brake and brake shoes and reduce the service life thereof.

DE10138494A1 discloses a solution in which a rotor disk or a motor shaft that is connected to a helical transmission is blocked. This “fixing device” is a bistable magnetic brake. Owing to the direct connection with the transmission, relatively great forces act on the locking bolt, and the fixing device, as an additional component, is not integrated in the electromechanical brake actuator.

A functional integration in the housing of the electromechanical brake actuator is not provided in DE10206786A1 either. The actuating device is flange-mounted here.

By contrast, the transmission of the brake actuator is locked in US 2015/0246662. As a result, relatively great forces act on a locking bolt. Furthermore, the locking device also here is a component which is additionally flange-mounted on the disk brake.

US 2006/0163939 likewise describes the locking or the braking of a rotor of an electric motor via a brake pad in order to realize a parking brake actuator. However, a bolt which is driven by an electric motor is used for the locking.

### SUMMARY

It is an object of the disclosure to provide an electromechanical disk brake having a parking brake actuator, which is cost-effective and requires little construction space.

This object can, for example, be achieved in that an electromechanical disk brake has a parking brake actuator which is embodied as an electromagnetic linear drive, and wherein an electric motor can be arrested by the electromechanical linear drive. Embodiments according to the disclosure use the main actuation branch of the electromechanical disk brake and extend the same by a linear drive. The main actuation branch should be understood as meaning the electric motor and an actuator which are used for the application of a brake disk via two brake pads. After a desired brake force is set via an actuation operation of the electric motor, the electric motor is arrested in the set position. The electromechanical disk brake maintains the set brake force which without a supply of additional holding energy for holding the electric motor in the set position. That is, the electromechanical disk brake is held exclusively by the form-fitting connection, which is introduced by the arresting operation, between the electric motor and the linear drive.

In an embodiment, the linear drive has a plunger and a rotor of the electric motor has latching grooves. In order to produce a force-fitting connection, the plunger engages in the latching grooves of the rotor while the electric motor is arrested. The latching grooves are advantageously arranged on the rotor at uniform intervals along the circumference of the rotor. The more latching grooves the rotor has, the more positions are provided for arresting the electric motor.

In a further embodiment, the linear drive is embodied as a solenoid. Solenoids are electromagnetic actuators which use an electrically generated magnetic field to exert a force on the plunger, also referred to as plunger core, such that the plunger is movable linearly in two directions. An electrical magnetic field is generated via a coil mounted around the plunger. Depending on the polarity, that is, positive polarity or negative polarity, the plunger is held in a starting position, or the plunger plunges in a form-fitting manner into a latching groove of the rotor and arrests the electric motor in the set position. The starting position is defined as the position of the plunger at which the plunger has not plunged into a latching groove of the rotor. The rotor can therefore fully rotate.

Furthermore, in a further embodiment, the linear drive is arranged radially, in the direction of the latching grooves, in an electric motor housing of the electromechanical disk brake. The linear drive is therefore integrated in the electromechanical disk brake. In more precise terms, the linear drive is arranged axially between a control unit of the electromechanical disk brake and a cam disk of the electromechanical disk brake and radially in the direction of the rotor.

In a further embodiment, the electric motor is embodied as an external-rotor motor, wherein the latching grooves are arranged on the rotor in a form-fitting manner in a radial direction. Electric motors have a stator and a rotor. An external-rotor motor refers to electric motors in which the stator, that is, the stationary part, is located in the interior of the electric motor, and the rotor, that is, the movable part, surrounds the stator. In contrast to a conventional constructional form of the electric motor as an internal-rotor motor, a circumferential surface of the external-rotor motor is directly accessible and predominantly does not carry out an electromagnetic function.

Furthermore, in a further embodiment, for the electrical activation of the linear drive, the linear drive is connected to a motor control unit via a cable connection. The motor control unit is configured for activation of the electric motor and can advantageously be arranged inside the electric motor. In particular, the motor control unit is arranged downstream of the linear drive, axially in the direction of the cam disk, such that a short cable connection is sufficient for the electrical connection of the linear drive. Furthermore, with the use of the motor control unit, no additional control unit is necessary for controlling the linear drive, as a result of which the cost of the electromechanical disk brake is reduced.

In an alternative embodiment, the linear drive is advantageously arranged axially parallel to an electric motor axis, in the direction of the latching grooves, in the electric motor housing of the electromechanical disk brake. In the alternative embodiment, the linear drive is embedded directly in the electric motor between the control unit and the rotor. The extra construction space in a vehicle because of the integration of the linear drive can be used in some other way. Furthermore, the linear drive is also protected better since the linear drive is arranged in the electric motor rather than on the electric motor.

Also in the alternative embodiment of the linear drive, the electric motor is embodied, in a further embodiment, as an external-rotor motor. The latching grooves are arranged on the rotor in a form-fitting manner in an axially parallel direction. The operating principle is the same as in the first embodiment, in which the linear drive engages radially in the latching grooves of the rotor.

In a further alternative embodiment, the linear drive is connected directly to the motor control unit. An additional external cable connection, that is, a cable connection arranged outside the electric motor housing, is omitted. Undesirable cable breakages due to actions outside the electric motor housing are eliminated.

In a further embodiment, the motor control unit for the alternative linear drive has a baseplate, wherein the baseplate is at least in sections part of the electric motor housing. The baseplate firstly ensures that the motor control unit is hermetically sealed, and secondly, the baseplate of the motor control unit integrates the solenoid, which is embodied as the linear drive, as an arresting device. The integration of the linear drive is achieved in particular by the fact that, during the manufacturing, the coil of the solenoid is inserted from the motor side, that is, the side on which the electric motor is flange-mounted on the cam disk.

In a further advantageous embodiment, the baseplate of the alternative linear drive has bores for the passage of a connecting line. The bores are furthermore filled with a thermoplastic compound for sealing the clearances of the bores. A clearance should be understood as meaning that space in the bores which is not filled by connecting lines.

So that the alternative linear drive is firmly fixed in the electric motor housing, in a further embodiment the bore holes and the coil of the electric motor, which coil is at least partially arranged in the motor control unit, are potted with the thermoplastic compound.

In a final embodiment, for the conversion of the rotating movement of the electric motor into a translatory movement, a transmission of the electromechanical disk brake has a cam disk. In addition, the electromechanical disk brake is embodied as a sliding calliper disk brake. The integration of the cam disk in the electromechanical disk brake makes it possible to omit a brake cylinder, or, in other words, the cam disk with the electric motor and the transmission replaces the brake cylinder. The compact configuration of the electromechanical sliding calliper disk brake equipped with the cam disk permits new fields of use in automotive engineering.

### BRIEF DESCRIPTION OF THE DRAWINGS

The invention will now be described with reference to the drawings wherein:

FIG. 1 shows a schematic illustration of an electromechanical disk brake, known from the prior art, with an electromechanical actuator;

FIG. 2 shows a sectioned side view of an electromechanical actuator according to FIG. 1 with a parking brake actuator, which is embodied as a linear drive and is integrated, according to a first embodiment; and,

FIG. 3 shows a sectioned side view of the electromechanical actuator according to FIG. 1 with a parking brake actuator, which is embodied as a linear drive and is integrated, according to a second embodiment.

### DESCRIPTION OF THE PREFERRED EMBODIMENTS

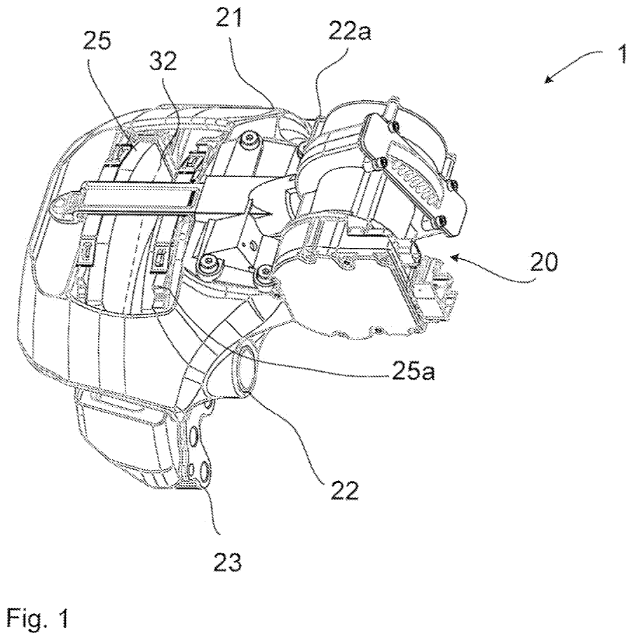

FIG. 1 shows an electromechanical disk brake 1. The disk brake 1 is embodied as a sliding calliper disk brake. A calliper 21 is mounted so as to slide axially on a brake anchor plate 23 via two plain bearings 22, 22a. An electromechanical actuator 20 applies a brake disk 32 via a rim-side brake pad 25 and an application-side brake pad 25a.

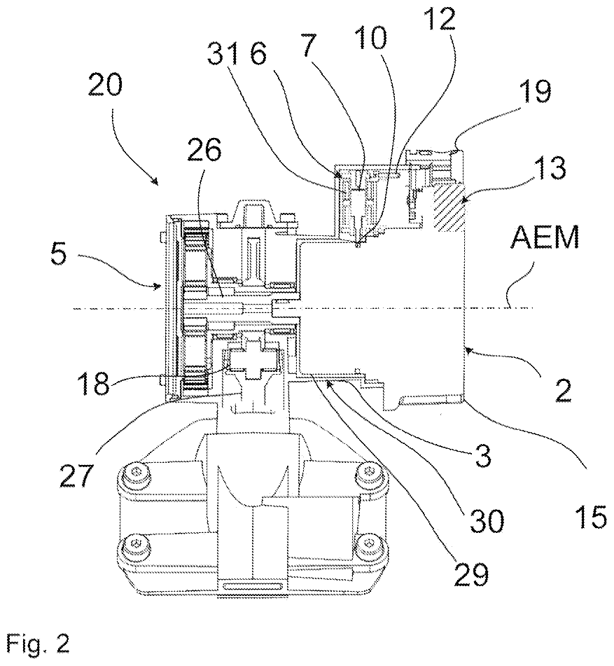

FIG. 2 shows the electromechanical actuator 20 having a parking brake actuator in a first embodiment for an electromechanical disk brake 1 according to FIG. 1 in detail. The electromechanical actuator 20 has an electric motor 2 axially along an electric motor axis AEM. The electric motor 2 is connected axially via a shaft 26 to a cam disk 18. Starting from the electric motor axis AEM, the cam disk 18 is arranged radially in the electromechanical actuator 20. The cam disk 18 which is operatively connected to the electric motor 2 is configured to convert a drive torque, that is, a rotating movement of the electric motor 2 about the electric motor axis AEM, into a translatory movement, that is, a linear movement, for actuating a brake plunger 27. The brake plunger 27 serves for actuating a rotary lever, not shown, for applying the brake disk 32. Furthermore, the electric motor 2 includes a transmission 5 which is arranged axially along the electric motor axis AEM and which is intended for applying a desired drive torque. A motor control unit 13 for regulating the actuator 20 is arranged in the electric motor housing 15 radially above the transmission 5. The motor control unit 13 is therefore integrated in a space-saving manner in the electric motor 2. A rotor 13 which is provided with latching grooves 10 is arranged in the electric motor 2 axially between the transmission 5 and the cam disk 18. During an actuation movement of the electromechanical actuator 20, the rotor 3 rotates about the electric motor axis AEM. The latching grooves 10 are arranged at uniform intervals along a circumferential surface 30 of the rotor 3. The rotor 3 surrounds an electromagnetic stator 29, referred to below as stator 29, of the electric motor 2. The rotor 3 predominantly takes on no electromagnetic function, contrary to the stator 29, and therefore the latching grooves 10 are arranged directly on the circumferential surface 30 of the rotor 3. For the engagement of a parking lock, a linear drive 6 which is configured as a parking brake actuator is arranged in the actuator 20 radially above the rotor 3. The linear drive 6 is embodied as a solenoid 6. For electrical activation of the solenoid 6, a cable connection 12 is connected to the solenoid 6 and to the motor control unit 13. For the engagement of the parking lock function, the rotor 3 rotates into a position in which a latching groove 10 and a plunger 7 of the solenoid 6 are arranged radially in a line so that the plunger can engage in the latching groove 10 on the rotor 3 and secures the electric motor 2 against rotation about the electric motor axis AEM. To release the parking lock function, the magnetic field of the solenoid 6 is changed so that the plunger 7 is moved back radially into the starting position, that is, out of the latching groove 10.

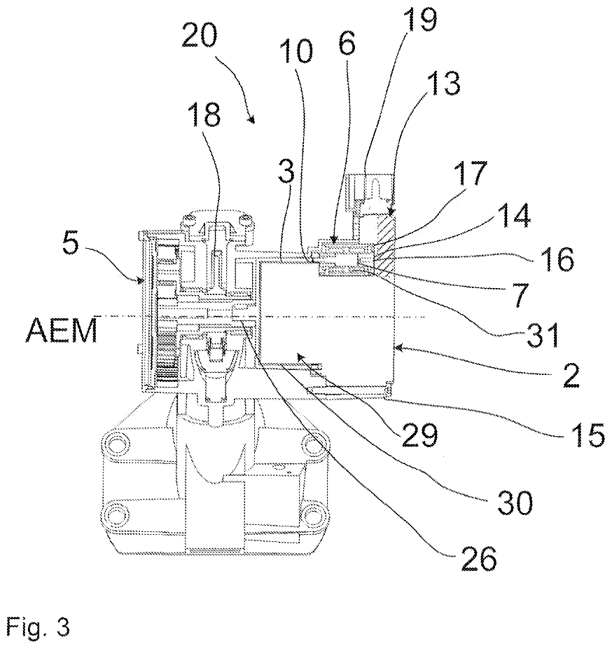

FIG. 3 shows the electromechanical brake actuator 20 according to FIG. 1 in a second alternative embodiment. The electromechanical actuator 20 is shown in a laterally sectioned view. In the second embodiment, the linear drive 6, which is configured as a parking brake actuator 6, is arranged in the electric motor 2 axially parallel to the electric motor axis AEM. In the second embodiment, the linear drive 6 is also embodied as a solenoid 6. The solenoid 6 is at the same time part of the electric motor housing 15. In more precise terms, the solenoid 6 is arranged axially between the motor control unit 13 and the rotor 3. A coil 31 for generating an electromagnetic field encases the plunger 7. Connecting lines 19 for connecting the solenoid 6 to the motor control unit 13 are guided through the baseplate 14 of the motor control unit 13 via bores 16. The bores 16 and the coil 31 are potted with a thermoplastic compound 17, wherein the coil 31 is fixed at the same time by the thermoplastic compound 17. In the second embodiment, the latching grooves 10 for engagement of the plunger 7 are arranged axially parallel on the rotor 3.

It is understood that the foregoing description is that of the preferred embodiments of the invention and that various changes and modifications may be made thereto without departing from the spirit and scope of the invention as defined in the appended claims.

### LIST OF REFERENCE SIGNS AS PART OF THE DESCRIPTION

1 Electromechanical disk brake
2 Electric motor
3 Rotor
5 Transmission
6 Parking brake actuator, linear drive, solenoid
7 Plunger
10 Latching grooves
12 Cable connection
13 Motor control unit
14 Baseplate of the motor control unit 13
15 Electric motor housing
16 Bores
17 Thermoplastic compound
18 Cam disk
19 Connecting line of the motor control unit 13
20 Electromechanical actuator
21 Calliper
22, 22a Plain bearings
23 Brake anchor plate
25 Rim-side brake pad
25a Application-side brake pad
26 Shaft
27 Brake plunger
29 Stator
30 Circumferential surface of the rotor 3
31 Coil
AEM Electric motor axis

What is claimed is:

1. An electromechanical disk brake for motor vehicles, the electromechanical disk brake comprising:
an electromechanical actuator having an electric motor with an electric motor housing and a rotor;
a transmission configured to apply a brake pad to a brake disk of the electromechanical disk brake;
said transmission being configured to convert a rotating movement of said electric motor into a translatory movement;
said electromechanical actuator having an electromagnetic linear drive; and,
wherein said electric motor can be arrested by said electromechanical linear drive.

2. The electromechanical disk brake of claim 1, wherein said linear drive has a plunger and said rotor has latching grooves; and, said plunger is configured to engage said latching grooves of said rotor in order to arrest said electric motor.

3. The electromechanical disk brake of claim 1, wherein said linear drive is embodied as a solenoid.

4. The electromechanical disk brake of claim 2, wherein said linear drive is arranged radially, in a direction of said latching grooves, in said electric motor housing.

5. The electromechanical disk brake of claim 2, wherein said electric motor is an external-rotor motor; and, said latching grooves are arranged on said rotor in a form-fitting manner in a radial direction.

6. The electromechanical disk brake of claim 2, wherein said linear drive is arranged axially parallel to an electric motor axis (AEM), in a direction of said latching grooves, in said electric motor housing.

7. The electromechanical disk brake of claim 6, wherein said electric motor is an external-rotor motor; and, said latching grooves are arranged on said rotor in a form-fitting manner in an axially parallel direction.

8. The electromechanical disk brake of claim 6 further comprising:
a motor control unit; and,
said linear drive being, for an electrical activation of said linear drive, connected to said motor control unit.

9. The electromechanical disk brake of claim 8, wherein said motor control unit has a baseplate; and, said baseplate is at least in sections part of said electric motor housing.

10. The electromechanical disk brake of claim 9, wherein said baseplate has bores; said bores are configured to provide a passage of a connecting line; and, said bores have a thermoplastic compound for sealing said bores.

11. The electromechanical disk brake of claim 10, wherein said linear drive is fixed in said electric motor housing by said thermoplastic compound.

12. The electromechanical disk brake of claim 1, wherein said transmission has a cam disk for converting the rotating movement of the electric motor into the translatory movement; and, the electromechanical disk brake is a sliding calliper disk brake.

13. The electromechanical disk brake of claim 1 further comprising:
a motor control unit;
a cable connection; and,
said linear drive being connected to said motor control unit via said cable connection for an electrical activation of said linear drive.
